(19) United States
(12) Patent Application Publication
(10) Pub. No.: US 2014/0106681 A1
(43) Pub. Date: Apr. 17, 2014

(54) Ku ADAPTATION FOR PHASE-LOCKED LOOP WITH TWO-POINT MODULATION

(71) Applicant: QUALCOMM INCORPORATED, San Diego, CA (US)

(72) Inventors: Lai Kan Leung, San Marcos, CA (US); Yiwu Tang, San Diego, CA (US); Chiewcharn Narathong, Laguna Niguel, CA (US)

(73) Assignee: Qualcomm Incorporated, San Diego, CA (US)

(21) Appl. No.: 13/650,844

(22) Filed: Oct. 12, 2012

(51) Int. Cl. H04B 1/62

(52) U.S. Cl. CPC H04B 1/62
USPC 455/73; 455/108

(57) ABSTRACT

A wireless device includes: an antenna; and a polar-modulation transmitter coupled to the antenna and configured for two-point modulation, the transmitter including: a data input; a first signal path including a multiplier coupled to the data input and a voltage-controlled oscillator gain adaptation module coupled to the multiplier and configured to provide a gain value to the multiplier; and a second signal path coupled to the data input and including an analog phase-locked loop (PLL) including a voltage-controlled oscillator (VCO) coupled to the first signal path.

### BACKGROUND

Polar modulation transmitters use synthesizers with two-point modulation (TPM). Such transmitters can be used in a variety of devices, including wireless communication devices such as tablet computers or mobile phones.

Mixed technology devices may use different types of transmitters, and thus different types of phase-locked loops (PLLs). For example, for 1xCDMA, WCDMA, or LTE, an analog PLL is often used due to low power consumption, good phase noise, and low spurs, while a digital PLL using TPM is often used for GSM transmitters. Using different types of transmitters, for example different transmitters in a multi-mode transceiver, with dedicated parts uses significant resources such as chip space.

### SUMMARY

An example of a wireless device includes: an antenna; and a polar-modulation transmitter coupled to the antenna and configured for two-point modulation, the transmitter including: a data input; a first signal path including a multiplier coupled to the data input and a voltage-controlled oscillator gain adaptation module coupled to the multiplier and configured to provide a gain value to the multiplier; and a second signal path coupled to the data input and including an analog phase-locked loop (PLL) including a voltage-controlled oscillator (VCO) coupled to the first signal path.

Implementations of such a device may include one or more of the following features. The device further includes at least one receiver including a pre-amplifier and an analog-to-digital converter (ADC), where the gain adaptation module includes the pre-amplifier and the ADC. The at least one receiver includes a primary receiver, a diversity receiver, and a feedback receiver, where the gain adaptation module is configured to use the pre-amplifier and the ADC of a selected receiver of the at least one receiver during an idle time of the selected receiver. The PLL includes a low-pass filter (LPF) and the pre-amplifier has a first input coupled to a zero of the LPF and a second input coupled to any one pole from a first to a last pole of the LPF. The pre-amplifier is configured to determine a difference between a signal received by the first input and a signal received by the second input to remove a DC component of the signal sent to the ADC. The LPF comprises a passive resistive-capacitive ladder, or an active filter with equal numbers of poles and zeros, with a second or higher pole being the final pole of the LPF. The device further includes a coarse-tune engine selectively coupled to the multiplier and configured to provide an initial value for the adjustable gain value in an open-loop manner. The gain adaptation module comprises a dynamic adjustment module configured to at least one of: provide a dynamic step of data provided to the data input; provide a dynamic bandwidth adjustment to a data signal received at the data input; or dynamically adjust a direct-current (DC) offset of an output of a signal multiplied by the data signal received at the data input.

An example of a method of transmitting data from a wireless telecommunication device includes: receiving an input data signal at a transmitter of the device, the transmitter being a first component of the device; applying first and second portions of the input data signal to first and second portions of the transmitter that output first and second output signals that have frequencies within first and second frequency ranges that are non-identical; responding to a trigger by performing adaptation of a gain value for the first output signal, the adaptation including: directing a first signal from the second portion of the transmitter through a multi-use portion of the device useable by a second component of the device, the second component of the device being a component of the device other than the transmitter; determining the gain value using the first signal output by the multi-use portion of the device; and multiplying the gain value with the first portion of the input data signal to produce the first output signal; the method further including: combining the first and second output signals to produce a transmit signal; and transmitting the transmit signal to transmit the data.

Implementations of such a method may include one or more of the following features. The directing includes directing the first signal through a filter and an analog-to-digital converter of a receiver of the device. The directing further includes directing a second signal from the second portion of the transmitter through the portion of the second component, where using the first signal includes taking a difference of the first and second signals from the second portion of the transmitter and where determining the gain value includes iterating the gain value to reduce the difference. The method further includes applying a direct current offset to the difference. Applying the direct current offset includes applying different direct current offsets at different times. The method further includes: providing a training signal as in the input data signal; and multiplying the difference by the training signal and a constant. The method further includes varying both a period of the training signal and a value of the constant over time.

Implementations of such a method may also, or alternatively, include one or more of the following features. The directing includes connecting the multi-use portion of the device to the first portion of the transmitter. The method further includes frequency filtering the first and second portions of the input data signal by the first and second portions of the transmitter such that the first frequency range includes frequencies higher than the second frequency range. Directing the first signal from the second portion of the transmitter through the multi-use portion of the device includes directing the first signal through the multi-use portion of the device during an idle time of the second component of the device. The method further includes: iterating the gain value to an adapted gain value such that the first and second output signals have a desired characteristic; and storing the adapted gain value; where multiplying the gain value with the first portion of the input data signal includes multiplying the adapted gain value once the adapted gain value is determined.

An example of a wireless device includes: means for receiving an input data signal at a transmitter of the device, the transmitter being a first component of the device; means for applying first and second portions of the input data signal to first and second portions of the transmitter that output first and second output signals that have frequencies within first and second frequency ranges that are non-identical; means for responding to a trigger by means for performing adaptation of a gain value for the first output signal in response to a trigger, the means for performing including: means for directing a first signal from the second portion of the transmitter through a multi-use portion of the device useable by a second component of the device, the second component of the device being a component of the device other than the transmitter; means for determining the gain value using the first signal output by the multi-use portion of the device; and means for multiplying the gain value with the first portion of the input data signal to produce the first output signal; the wireless device further including: means for combining the first and second output signals to produce a transmit signal; and means for transmitting the transmit signal to transmit the data.

Implementations of such a device may include one or more of the following features. The means for directing includes means for directing the first signal through a filter and an analog-to-digital converter of a receiver of the device. The means for directing further includes means for directing a second signal from the second portion of the transmitter through the portion of the second component, where using the first signal includes taking a difference of the first and second signals from the second portion of the transmitter and where the means for determining the gain value includes means for iterating the gain value to reduce the difference. The device further includes means for applying a direct current offset to the difference. The means for applying the direct current offset includes means for applying different direct current offsets at different times. The device further includes: means for providing a training signal as in the input data signal; and means for multiplying the difference by the training signal and a constant. The device further includes means for varying both a period of the training signal and a value of the constant over time.

Implementations of such a device may also, or alternatively, include one or more of the following features. The means for directing includes means for connecting the multi-use portion of the device to the first portion of the transmitter. The device further includes means for frequency filtering the first and second portions of the input data signal by the first and second portions of the transmitter such that the first frequency range includes frequencies higher than the second frequency range. The means for directing the first signal from the second portion of the transmitter through the multi-use portion of the device includes means for directing the first signal through the multi-use portion of the device during an idle time of the second component of the device. The device further includes: means for iterating the gain value to an adapted gain value such that the first and second output signals have a desired characteristic; and means storing the adapted gain value; where multiplying the gain value with the first portion of the input data signal includes multiplying the adapted gain value once the adapted gain value is determined.

An example of a processor-readable storage medium includes processor-readable instructions configured to cause a processor to: cause first and second portions of an input data signal, received at a transmitter of a wireless device, to be applied to first and second portions of the transmitter that output first and second output signals that have frequencies within first and second frequency ranges that are non-identical, the transmitter being a first component of the device; respond to a trigger by performing adaptation of a gain value for the first output signal, the adaptation including: directing a first signal from the second portion of the transmitter through a multi-use portion of the device useable by a second component of the device, the second component of the device being a component of the device other than the transmitter; determining the gain value using the first signal output by the multi-use portion of the device; and multiplying the gain value with the first portion of the input data signal to produce the first output signal; the instructions further including instructions configured to cause the processor to: combine the first and second output signals to produce a transmit signal; and transmit the transmit signal to transmit the data.

Implementations of such a storage medium may include one or more of the following features. The directing includes directing the first signal through a filter and an analog-to-digital converter of a receiver of the device. The directing further includes directing a second signal from the second portion of the transmitter through the portion of the second component, where using the first signal includes taking a difference of the first and second signals from the second portion of the transmitter and where determining the gain value includes iterating the gain value to reduce the difference. The processor-readable storage medium further includes instructions configured to cause the processor to apply a direct current offset to the difference. The instructions configured to cause the processor to apply a direct current offset are configured to cause the processor to apply different direct current offsets at different times. The processor-readable storage medium further includes instructions configured to cause the processor to: provide a training signal as in the input data signal; and multiply the difference by the training signal and a constant. The processor-readable storage medium further includes instructions configured to cause the processor to vary both a period of the training signal and a value of the constant over time.

Implementations of such a storage medium may also, or alternatively, include one or more of the following features. The directing includes connecting the multi-use portion of the device to the first portion of the transmitter. The processor-readable storage medium further includes instructions configured to cause the processor to frequency filter the first and second portions of the input data signal by the first and second portions of the transmitter such that the first frequency range includes frequencies higher than the second frequency range. Directing the first signal from the second portion of the transmitter through the multi-use portion of the device includes directing the first signal through the multi-use portion of the device during an idle time of the second component of the device. The processor-readable storage medium further includes instructions configured to cause the processor to: iterate the gain value to an adapted gain value such that the first and second output signals have a desired characteristic; and store the adapted gain value; where the instructions configured to cause the processor to multiply the gain value with the first portion of the input data signal comprise instructions configured to cause the processor to multiply the adapted gain value once the adapted gain value is determined.

Items and/or techniques described herein may provide one or more of the following capabilities, as well as other capabilities not mentioned. Chip area may be conserved by not using dedicated blocks for a digital PLL, e.g., a phase-to-digital converter, or a digital loop filter. Spur reduction may be achieved, e.g., with less digital blocks resulting in less clock activities resulting in lower spurs. With less spurs, chip area can be further conserved by simplifying the modem-to-transceiver interface and regulators for the blocks used in the digital PLL. Power consumption and reference clock rate can be better decoupled. A reference clock of higher frequency for better IPN/wider bandwidth/less pulling can be used with less penalty on power consumption. A simpler power grid for a transceiver synthesizer can be used. Design requirements and layout of the regulators can be simplified, removed or shared if the power grid is simplified. A smaller number of external bypass components on an analog PLL can be used. Integrated phase noise (IPN) can be improved. A charge pump can be used with a large linear range. During Ku adaptation, an analog-to-digital converter (ADC) (e.g., of a transceiver) and a receiver base band filter (in a primary or diversity or feedback receiver) can be shared to reduce the hardware overhead. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a block diagram of a wireless telecommunication device.

FIG. 2 is a schematic diagram of an example of a transmitter synthesizer using two-point modulation and an analog phase-locked loop.

FIG. 3 is a schematic diagram of a gain adaptation block and a low-pass filter shown in FIG. 2.

FIG. 4 is a circuit diagram of a receiver baseband filter shown in FIG. 3.

FIG. 5 is a block flow diagram of operation of a controller shown in FIG. 3.

FIG. 6 is a timing diagram of timing control of a coarse-tune engine shown in FIG. 3.

FIG. 7 is a timing diagram of an initial VCO gain calculation.

FIG. 8 is a block flow diagram of a process of operation of a transmitter shown in FIG. 1.

FIG. 9 is a block flow diagram of a process of operation of the transmitter synthesizer shown in FIGS. 2-3 of a transmitter shown in FIG. 1.

### DETAILED DESCRIPTION

Techniques are provided for implementing a device that uses an analog PLL for polar modulation with two-point modulation (TPM). The device may be part of a transmitter or a transceiver, and more than one transmitter and/or transceiver, or combinations thereof, may be provided in an apparatus. The device may be used in multi-standard devices, e.g., capable of processing signals in accordance with two or more of GSM/EDGE, CDMA, LTE, and WCDMA standards. The techniques discussed provide for adaptive gain and delay so that signals of two branches of a TPM device are balanced in magnitude and timing. The techniques preferably provide good power consumption characteristics and reduced chip space usage compared to prior techniques. The proposed devices are hardware efficient because a transmitter uses components from another component, e.g., a receiver, to implement voltage-controlled oscillator (VCO) gain adaptation as part of the analog PLL with polar modulation. Thus, at least some hardware may not be dedicated exclusively to the gain adaptation, it may be non-dedicated, multi-use hardware.

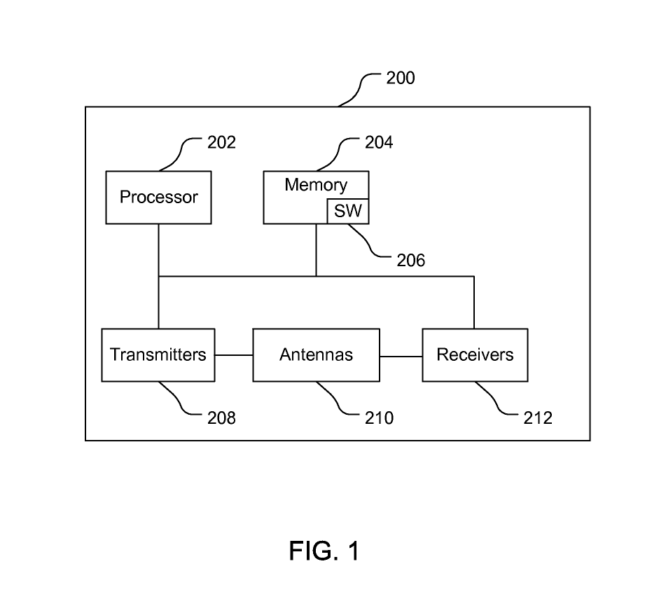

Referring also to FIG. 1, an example of a wireless telecommunication device 200 includes: a computer system including a processor 202 and a memory 204 including software 206; transmitters 208; antennas 210; and receivers 212. The device 200 is preferably a mobile device such as a mobile phone, smart phone, tablet computer, laptop computer, etc. One or more of the transmitters 208 and one or more of the receivers 212 may form respective parts of one or more transceivers of the device 200. Although the device 200 here includes multiple transmitters 208, antennas 210, and receivers 212, alternatively the device 200 could include a single one of any of these components. The transmitters 208, antennas 210, and receivers 212 form a wireless communication module. The transmitters 208 and receivers 212 are configured to communicate bi-directionally with wireless communication nodes, such as base stations, via the antennas 210. The processor 202 is preferably an intelligent hardware device, e.g., a central processing unit (CPU) such as those made by ARM®, Intel® Corporation, or AMD®, a microcontroller, an application specific integrated circuit (ASIC), etc. The processor 202 could comprise multiple separate physical entities that can be distributed in the device 200. The memory 204 includes random access memory (RAM) and read-only memory (ROM). The memory 204 stores the software 206 which is computer-readable, computer-executable software code containing instructions that are configured to, when executed, cause the processor 202 to perform various functions described herein. Alternatively, the software 206 may not be directly executable by the processor 202 but configured to cause the processor, e.g., when compiled and executed, to perform the functions.

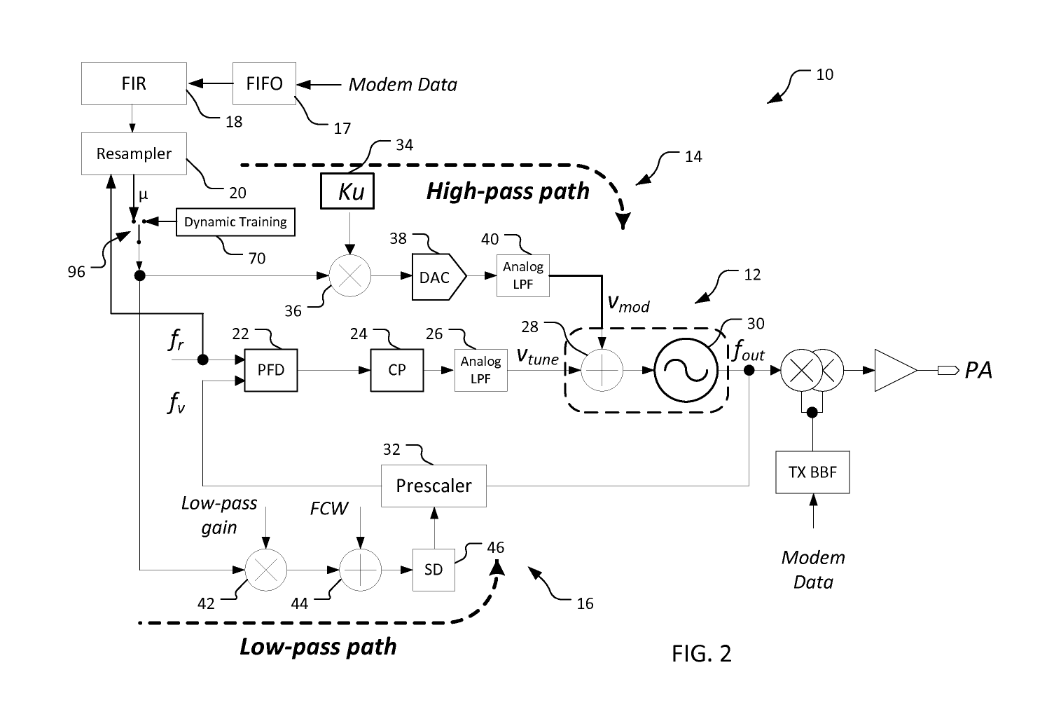

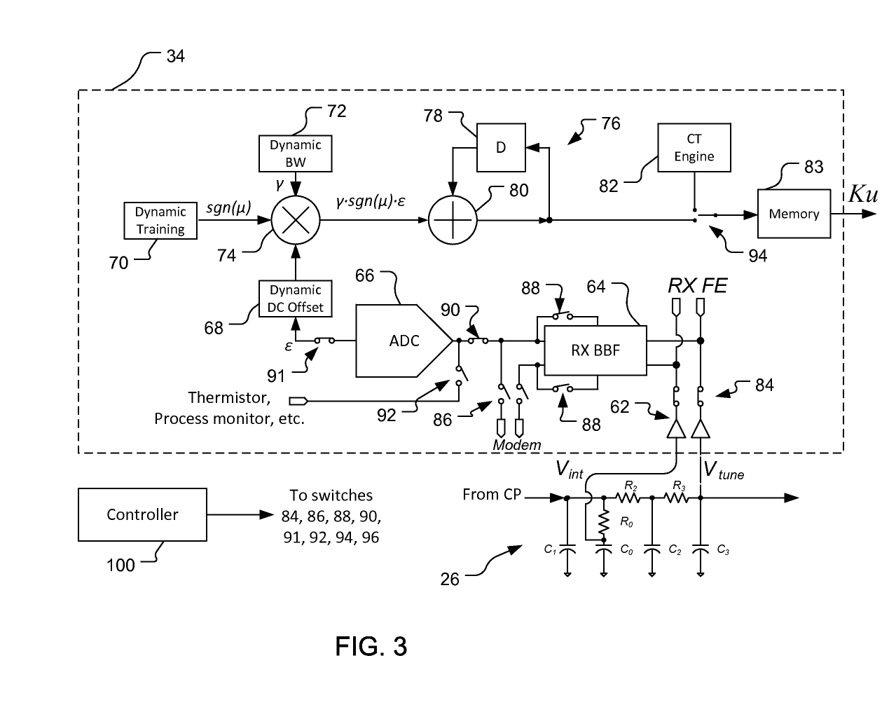

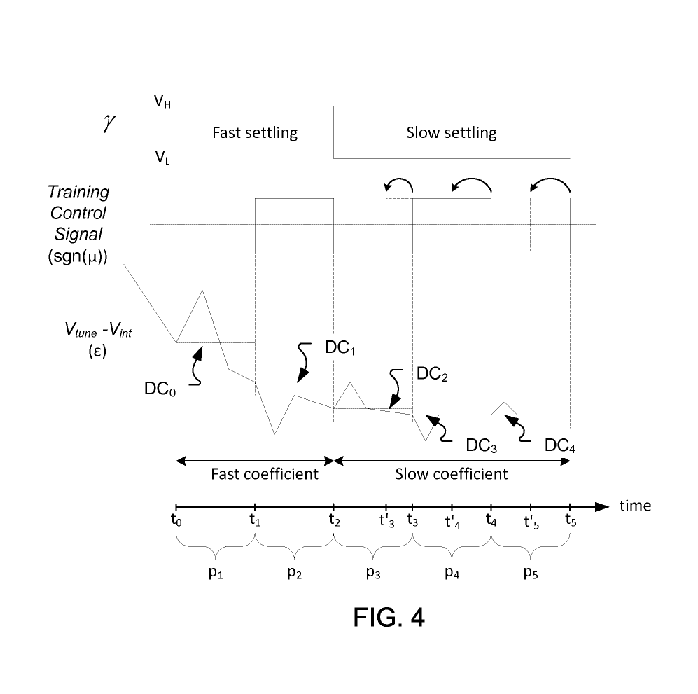

Referring to FIG. 2, a transmitter 10 (which may be part of a transceiver) includes a PLL 12, a first-in first-out (FIFO) buffer 17, a digital filter 18, here a finite impulse response (FIR) filter, a resampler 20, a dynamic training module 70, a multiplier 42, an adder 44, and a sigma-delta modulator 46. The transmitter 10 is one of the transmitters 208 of the wireless telecommunication device 200 shown in FIG. 1. The multiplier 42, the adder 44, and the sigma-delta modulator 46 form a low-pass data path 16 and a high-pass path 14 includes a VCO gain (Ku) adaptation module 34, a multiplier 36, a digital-to-analog converter (DAC) 38, and an analog LPF 40. The PLL 12 includes a phase frequency detector (PFD) 22, a charge pump (CP) 24, an analog low pass filter (LPF) 26, an adder 28, a voltage-controlled oscillator (VCO) 30, and a prescaler 32. While the adder 28 is shown separate from the VCO 30, the adder 28 may be part of the VCO 30, and thus shown separately here conceptually and for ease of understanding. The adder 28 is configured to add the frequencies of a Vₜᵤₙₑ signal, from the low-pass path 16, and a V_{mod} signal, from the high-pass path 14, in the capacitive domain, although adding in the capacitive domain is just one example. The buffer 17 buffers the data from a modem to align the timing of the data with the timing of the transmitter 10 due to different asynchronous clock domains of the modem, for example, on one chipset, and the transmitter 10, for example, on another chipset. The filter 18 is configured to reconstruct and filter data from the buffer (from the modem). The resampler 20 is configured to resample (upsample or downsample) the data from the filter 18 to convert the fixed data rate from the filter 18 to the data rate of the PLL 12, which may vary. As more fully described below with respect to FIGS. 3-4, the dynamic training module 70 is configured to generate and provide a square wave indicative of a sign of a theoretical data signal. A selector switch 94, is configured to respond to a control signal to connect either the resampler 20 or the module 70 to the multipliers 36, 42 to supply either the data signal from the resampler 20 or the synthesized signal from the dynamic training module 70 to the multipliers 36, 42. Use of the high-pass path 14 and the low-pass path 16 enable the use of the PLL 12 with a smaller bandwidth than the input data signal from the resampler 20.

The transmitter 10 has high-pass and low-pass characteristics. The VCO-to-PLL output has a high-pass characteristic, with the high-pass point being the input of the DAC 38 which is outside the PLL loop. The high-pass path 14 attenuates a low-frequency component of the data from the resampler 20, with the LPF 40 configured to attenuate high-frequency noise of the DAC 38 without substantially affecting the data. This high-frequency noise is of much higher frequency than the bandwidth of the data (i.e., the cutoff frequency of the LPF 40 is much higher than the frequency of the data, and much higher than the cutoff frequency of the LPF 26). The prescaler-to-PLL output has a low-pass characteristic, with the low-pass point being the input of the sigma-delta (ΣΔ) modulator in the feedback path (digital). The low-pass path 16 attenuates a high-frequency component of the data from the resampler 20. Thus, the high-pass path 14 outputs a high-frequency component of the input data from the resampler 20 and the low-pass path 16 outputs a low-frequency component of the input data from the resampler 20.

The high-pass data path 14 provides a high-frequency component of the input data μ to the VCO 30. The input data from the resampler 20 is provided to the multiplier 36, that is configured to multiply the input data μ by a gain Ku, produced in the VCO gain adaptation block 34. The result from the multiplier 36 is converted from digital to analog form by the DAC 38 and high-frequency noise is filtered out by the LPF 40. The result is the voltage V_{mod} that is provided to the adder 28.

The low-pass data path 16 provides a low-frequency component of the input data μ to the prescaler 32. The input data μ is provided by the resampler 20 to the multiplier 42 that is configured and coupled to multiply the input data signal μ by a low-pass gain value and provide the result to the adder 44. The adder 44 is configured and coupled to add the output of the multiplier 42 to a frequency control word (FCW) signal and provide the result to the sigma-delta modulator 46 that converts the incoming analog signal to digital form and provides the digital signal to the prescaler 32. The prescaler 32 processes an output signal of frequency fₒᵤᵣ produced by the VCO 30 and the output from the modulator 46 to produce a first PFD input signal of frequency fᵥ. The first PFD input signal and a second PFD input signal, of frequency fᵣ, are provided to the PFD 22, whose output is provided to the CP 24, whose output is provided to the ALPF 26. The voltage Vₜᵤₙₑ is output by the ALPF 26 to the adder 28, that is coupled and configured to add the voltage Vₜᵤₙₑ to the voltage V_{mod} as discussed above.

The Ku adaptation block 34 is configured to determine and provide a gain in order to substantially match or balance the magnitudes of signals provided to the VCO 30 from the high-pass data path 14 and the low-pass data path 16 such that the gains in the high-pass path 14 and the low-pass paths 16 are preferably equal, or within an acceptable tolerance of each other. For example, the signals may be considered balanced if the combined signal output by the VCO 30 meets desired requirements, e.g., GSM requirements. Delay modules, not shown, are provided in the high-pass path 14 and the low-pass path 16 to provide delays, which may be different from each other, such that the propagation time of the input data signals through the paths 14, 16 are substantially equal, e.g., within a timing tolerance such as one reference clock cycle.

The transmitter 10 provides various features. The list below provides examples of features provided by the transmitter 10, but is not an exhaustive list.

1. The transmitter 10 includes an analog phase-locked-loop (APLL) with two-point modulation (TPM) using a hardware-efficient closed-loop Ku adaptation module 34. The low-pass path data is injected into a sigma-delta modulator controlling a divider and the high-pass path data is injected into a modulation varactor of the VCO 30. A Vₜᵤₙₑ varactor of the VCO 30 is connected to the outputs of the LFPs 26, 40. In this way, the frequencies of the low-pass path data and the high-pass path data are added in the capacitive domain (with adding in the capacitive domain being just one example).

2. Referring to FIG. 3, the low-pass filtered output in the loop filter is used to increase its signal-to-noise ratio before being sent to the Ku adaptation module 34. A difference between the low-pass filtered voltage and the integrating capacitor voltage in the loop filter is determined to reduce or even remove a DC component instead of using a large AC coupling capacitor. The difference can be determined by subtracting the low-pass filtered voltage from the integrating capacitor voltage or by subtracting the integrating capacitor voltage from the low-pass filtered voltage.

3. Closed-loop Ku adaptation with dynamic DC offset compensation, dynamic bandwidth and dynamic training is used to reduce the Ku adaptation convergence time and increase the efficiency of Ku adaptation.

4. A coarse tune engine can estimate the gain of the modulation varactor and convert this gain as the initial condition of the adaptation block. Thus, a dedicated calibration may or may not be used.

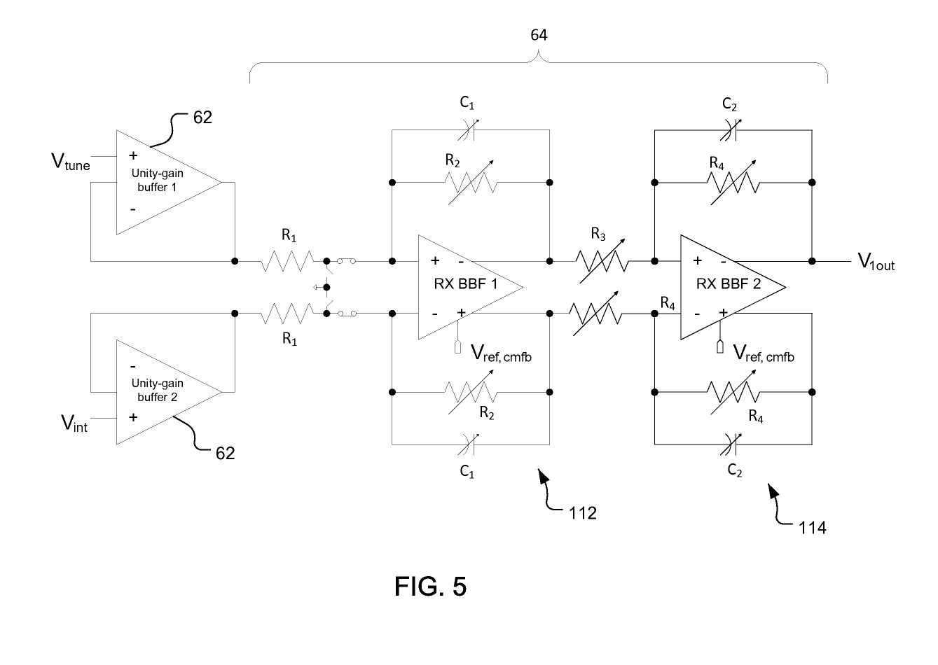

5. During Ku adaptation, a receiver baseband filter (RX BBF) in a primary, a diversity, or a feedback receiver is reused as a pre-amplifier, in time division duplex (TDD) or frequency division duplex (FDD) modes, to further enhance the signal-to-noise ratio of the signals sent to an ADC, preferably fulfilling an ADC INL/DNL (Integral-Non-Linearity/Differential-Non-Linearity) requirement. The RX BBF is connected back to the corresponding receiver front-ends after Ku adaptation. Details of this are provided in the discussion below with respect to FIG. 5.

6. During Ku adaptation, an ADC is reused for converting the voltages in the loop filter to digital codes, which are sent to the input of the Ku adaptation. The ADC is freed for other functions in TDD or FDD modes when not in use for Ku adaptation.

Referring also to FIG. 3, details of the adaptation block 34 and the LPF 26 are provided. The adaptation block 34 includes a pair of unity gain buffers 62, a receiver base band filter (RX BBF) 64, an analog-to-digital converter (ADC) 66, a dynamic DC offset compensation module 68, a dynamic training module 70, a data sign module 71, a dynamic bandwidth module 72, a multiplier 74, an accumulator 76 (including a D flip-flop 78 and an adder 80), a coarse-tune (CT) engine 82, and a memory 83. The LPF 26 comprises a passive (resistive-capacitive) R-C ladder. Alternatively, the LPF 26 could comprise an active filter with equal numbers (quantities) of poles and zeros. The Ku adaptation block 34 acts to balance the magnitude of different paths of input data for the PLL 12. The ADC output can have its DC bias adjusted dynamically in the digital domain, the data from the resampler 20 can have dynamic training, and dynamic bandwidth adjustment can be applied to the multiplier 74, which helps reduce convergence time and improve efficiency of the adaptation block 34.

The transmitter 10 uses the analog PLL 12 and provides closed-loop Ku adaptation. The closed-loop Ku adaptation is provided by a combination of the dynamic bandwidth (BW) module 72, the dynamic training module 70, the multiplier 74, the accumulator 76, the CT engine 82, a dynamic DC offset compensation module, the ADC 66, the RX BBF 64, and a pair of unity-gain buffers 36. The ADC 66 and the RX BBF 64 are shared with the other functions in the transmitter for converting voltages in the loop filter into digital information for the closed-loop Ku adaptation.

When input data change, the PLL 12 is disturbed, and voltages at different points in the LPF 26 will be significantly different. This difference induces a change in the Ku gain value provided by the Ku adaptation block 34 in order to balance magnitudes of data signals in the high-pass path 14 and the low-pass path 16 of the transmitter 10.

Ku Adaptation

Ku Adaptation Formula

The Ku adaptation provided by the adaptation block 34 is based on a signed least mean squared (LMS) algorithm. For this algorithm, an error is determined at an output and the present Ku gain, starting with an initial value, is changed in order to reduce the error to an acceptable level. To avoid saturating the ADC 66, small signal, delta voltages are amplified by the RX BBF 64 with variable gain before being sent to the ADC 66. The Ku adaptation can be modeled by

$$\frac{\partial Ku}{\partial t} = γ μɛ \qquad ( 1 )$$

where γ is a constant defining a bandwidth of a Ku adaptation loop (i.e., the adaptation block 34), μ is input data from the resampler 20 to the Ku adaptation block 34, and ε is an error due to a difference between inputs to the Ku adaptation block 34 from the LPF 16. Thus, the adaptation block 34 receives the data μ and the error ε (i.e., inputs from which the error is derived) as inputs, and outputs the gain Ku in order to reduce the error ε.

The Ku adaptation block 34 implements Eqn. (1) in discrete time using digital signals. In discrete terms, Eqn. (1) can be rewritten as

Ku[n]=γ·μ[n]·ε[n]+Ku[n−1] (2)

where Ku[n] is the gain value Ku at sample n, Ku[n−1] is the gain value Ku at the sample n−1, μ[n] is the input data at sample n, εe[n] is the error at sample n, and γ is the constant defining the bandwidth of the Ku adaptation loop.

Instead of the actual data signal μ[n], the sign of this signal may be used. This may result in a longer convergence time of the gain value Ku, but reduces hardware complexity of the adaptation block 34 by enabling an approximation of the first term (for example, by only taking the MSB of μ[n]) in Eqn. (2) to be determined using a single multiplier instead of two multipliers. Using this approximation, Eqn. (2) becomes

Ku[n]=γ·sgn(μ[n])·ε[n]+Ku[n−1] (3)

Implementation of Ku Adaptation Formula

To implement Ku adaptation, the adaptation block 34 uses four inputs, one being a synthesized signal representative of the sign of data sgn(μ) from the dynamic training module 70, one being a voltage, Vᵢₙₜ, from the LPF 26 one being a voltage, Vₜᵤₙₑ, from the LPF 26, and one being the dynamic bandwidth constant γ. These inputs provide the input data sign sgn(μ), signals from which the error ε in Eqn. (1) is determined, and γ.

Data Input

A controller 100 is configured to regulate the data input to the PLL 12. The controller 100 is configured to cause a switch 96 (FIG. 2) to connect the dynamic training module 70 to the PLL 12 during Ku adaptation and to connect the resampler 20 to the PLL 12 otherwise. The controller 100 is configured to respond to one or more conditions, e.g., when the PLL is powered up before the start of a GSM time slot, to initiate Ku adaptation by causing (actuating as appropriate) the switch 96 to connect the PLL 12 to the dynamic training module 70 so that the module 70 can supply a training signal to the PLL 12. The controller 100 is configured to respond to Ku adaptation completing, e.g., an error signal value reaching a desirable value (e.g., below a threshold value), by causing (actuating as appropriate) the switch 96 to connect the resampler 20 to the PLL 12 (and disconnect the module 70 from the PLL 12 if appropriate). Signals from the dynamic training module 70 provide the sgn(μ) input for Eqn. (3) to the PLL, and signals from the resampler 20 provide data input μ to the PLL 12. In either case, signals provided to the PLL 12 induce an error signal if the gain value Ku is not ideal.

Error Signal Determination

The voltages Vᵢₙₜ and Vₜᵤₙₑ are used to determine the error in Eqn. (1) for determining the gain Ku. The signals Vₜᵤₙₑ and Vᵢₙₜ are filtered and amplified by a pre-amplifier, comprising the unity-gain buffers 62 and the RX BBF 64. To avoid saturating the ADC 76, the delta between these signals is used to eliminate their DC components. These small-signal, delta voltage signals are amplified and filtered by the RX BBF 64 with variable gain before being sent to the ADC 66. The difference of these signals, i.e., the error signal, is determined, amplified and filtered by the RX BBF 64 to increase the error signal's signal-to-noise ratio (SNR) and such that the desired error signal dominates noise from the PLL 12. The voltages Vᵢₙₜ and Vₜᵤₙₑ are taken from different poles of the LPF 26, here Vᵢₙₜ being taken from a zero of the LPF 26, and Vₜᵤₙₑ being taken from the last pole of the LPF 26. The voltages could be taken from poles other than the first and last poles, e.g., with Vₜᵤₙₑ being taken from any pole other than the first pole (i.e., of the second or higher pole). The LPF 26 here comprises a multi-order R-C ladder and the Vₜᵤₙₑ voltage provides the cleanest voltage from the last pole of the LPF R-C ladder. The Vᵢₙₜ voltage and the Vₜᵤₙₑ voltage have nearly the same or the same DC component and are fed in to the RX BBF 64 via the unity gain buffers 62. The unity-gain buffers 62 are placed close to the loop filter 26 and remain on either after Ku adaptation is completed or during the whole TDD transmit (TX) uplink time (TX slot) and shut off during the downlink time (RX slot) or other modes.

The error signal is amplified by the RX BBF 64 such that the error signal's amplitude will be within a detectable range of the ADC 66. The signal swing in the loop filter 26 is in the sub-milli-volt range. As an example, if the ADC 66 has an effective number of bits of 11, a reference voltage of 1.2V (bandgap voltage is used as the reference), then a resolution of the ADC 66 with a full-swing input voltage of 1.2V is 1.2/2¹¹˜0.6 mV. By setting the gain factor of the RX BBF larger than 10, the minimum voltage range sent to the ADC 66 is much more than 1 mV and the ADC sensitivity requirement can be relaxed.

The error signal of the amplified difference of Vₜᵤₙₑ and Vᵢₙₜ is input into the ADC 66. The ADC 66 is configured to convert the analog output of the RX BBF 64 into a digital output signal.

The digital output signal from the ADC 66 is the error signal ε and is fed to the dynamic DC offset compensation module 68. The signal output from the dynamic DC offset compensation module 68 is provided to the multiplier 74 for multiplication with either the sgn(μ) value output by the dynamic training module 70 or the input data μ from the resampler 20, and the constant γ output by the dynamic bandwidth module 72. The multiplier 74 is configured to multiply the sgn(μ) signal by either altering (i.e., changing from 0 to 1 or from 1 to 0) or leaving alone the most significant bit (MSB) of the error signal ε, depending on the value/polarity of sgn(μ), and to multiply the result by the bandwidth constant γ.

Dynamic DC Offset Compensation, Training, and Bandwidth Constant

Regarding feature 3 above, with reference to FIGS. 3 and 4, the transmitter 10 can provide closed-loop Ku adaptation with dynamic DC offset compensation, a dynamic bandwidth constant, and dynamic training. The dynamic DC offset compensation module 68, the dynamic training module 70, and the dynamic BW module 72 are provided to help reduce the time for the gain Ku to reach a desirable value.

Dynamic DC Offset Compensation

A DC bias in the error signal ε changes over time due to PLL frequency settling, as the Ku adaptation is preferably started, due to the timing constraint, after the PLL 12 begins trying to lock but before the PLL 12 is fully settled. Thus, while PLL 12 is attempting to lock, the Ku adaptation is in progress (and the Ku value is settling). While the PLL 12 is settling, the voltage through the LPF 26 will be changing, resulting in a changing difference between the voltages Vₜᵤₙₑ, Vᵢₙₜ. Thus, there will be a DC component of the error signal (Vₜᵤₙₑ−Vᵢₙₜ, or Vᵢₙₜ−Vₜᵤₙₑ) that changes over time as the PLL 12 settles until the PLL 12 is fully settled. For the gain calibration, however, preferably there is no DC component of the error signal and only the AC component of the error signal is used to avoid saturation of the accumulator 76.

The dynamic DC offset compensation module 68 is configured to remove residual DC offset in the error signal remaining after a difference of Vᵢₙₜ and Vₜᵤₙₑ is determined by the RX BBF 64. Thus, the DC offset compensation module 68 is configured to reduce the DC component of the error signal from the ADC 66 by a compensation amount that the module 68 dynamically changes over time to correspond to the changing DC component of the error signal due to the changing voltage passing through the LPF 26. The dynamic DC offset compensation module 68 is configured to average the output of the ADC 66 over a period of time to determine the DC offset and to subtract a corresponding compensation amount from the present output of the ADC 66 to remove the DC offset. Referring to FIG. 4, the module 68 is configured to capture the last ADC output before the coming transition of the training control signal, when the PLL 12 has settled for a predetermined amount of time. The captured data is then averaged with the previous captured data to determine the next DC offsets, DC1-DC4. The module 68 will subtract the last-determined offset from the present output of the ADC 66 for a given time period, e.g., subtract DC₀ during time period p₁, subtract DC₁ during period p₂, etc. An initial DC offset is roughly estimated.

Dynamic Training

As shown in FIG. 4, the error signal ε has a spike beginning at each of times t₀-t₄, caused by each transition of the training control signal. A training control signal is a binary bit stream, for example a square wave, representing the sign of a theoretical input data signal and thus a synthesized sgn(μ). Transitions in the training control signal induce changes in the value of Ku which induce the spikes in the error signal ε. These spikes last for less than the respective time periods p₁-p₅ due to the PLL 12 adapting to the new Ku value and beginning to settle. Indeed, as time progresses, the spike magnitudes decrease and the spike durations decrease as the PLL 12 settles faster and faster due to the VCO gain Ku approaching a steady-state value, corresponding to the correct high-pass path gain and thus the error signal ε approaching zero. As the spike durations decrease, the training control signal can be dynamically adjusted to have a shorter period. For example, as shown in FIG. 4, the training control signal can be changed such that transitions that would occur at times t₃, t₄, and t₅ without adjustment occur at times t′₃, t′₄, and t′₅ with adjustment. A controller 100 is configured to cause the switch 96 (FIG. 2) to connect the dynamic training module 70 to the PLL 12 (FIG. 2), to supply the training signal to the PLL 12, during Ku adaptation and to disconnect the module 70 from the PLL 12 and connect the resampler 20 (FIG. 2) to the PLL 12 during times that Ku adaptation is not being performed. The controller 100 is configured to actuate the switch 96 e.g., when the PLL 12 is powered up at the beginning of a GSM time slot.

Dynamic Bandwidth Constant

Regarding dynamic bandwidth, different bandwidth constants can be used at different times during Ku adaptation. Applying Eqn. (3), a larger value of γ will provide faster Ku adaptation settling, but less accuracy (i.e., a less accurate end value of Ku) compared to a lower value of γ, which will provide slower Ku adaptation settling, but a more accurate end value of Ku, i.e., providing better matching between the high-pass path 14 and the low-pass path 16. Consequently, a large bandwidth constant value is preferably used in the beginning of Ku adaptation to reduce the initial difference quickly and a small bandwidth constant value is preferably used later for improving the accuracy slowly. The closer the Ku value is to an ideal value, the faster the disturbance settles. Therefore, efficiency can be improved by reducing the training step size dynamically close to the end of the Ku adaptation.

Referring to FIG. 4, at the beginning of Ku adaptation, the dynamic bandwidth module 72 generates and provides a value of γ that is relatively high to provide coarse tuning of Ku. From time t₀ the value of γ is set to a value V_{H}. The value of γ remains at this level for a time, here until the value of the error signal ε falls below a threshold value, which occurs in the example shown in FIG. 4 at the time t₂. At this time, the dynamic bandwidth module 72 reduces the value of γ to a relatively low value V_{L}. While only two values of γ are shown, more than two values may be used. Further, the time at which a transition from one value of γ to another value of γ occurs may be based on one or more criteria such as a fixed amount of time, or until the error signal ε falls below a threshold value (as here).

Combining Data, Error, and Bandwidth Constant to Determine Ku

The multiplier 74 and the accumulator 76 implement the Ku gain calculation provided in Eqn. (3). The multiplier 74 produces the first term of Eqn. (3) (i.e., the product γ·sgn(μ[n])·ε[n]) and the accumulator 76 adds this product to the previous gain value Ku[n−1] to yield the sum indicated in Eqn. (3). The multiplier 74 multiplies the error signal ε by the synthesized data sign signal sgn(μ) by adjusting the MSB if appropriate, and multiplies the result by the dynamic bandwidth constant γ to yield the product in Eqn. (3).

The outputs of the multiplier 74 are accumulated by the accumulator 76. The accumulator 76 delays the previous output of the accumulator 76 and adds this to the present output of the multiplier 74. The D flip-flop 78 delays the output of the adder 80, which is the previous gain value, Ku[n−1], from Eqn. (3) and feeds this value to the adder 80 that is coupled and configured to add that value to the present value of the output of the multiplier 74, which is the γ·sgn(μ[n])·ε[n] term from Eqn. (3). This sum is then the present value of the gain value Ku[n].

The present gain value Ku[n], or simply Ku, is provided to the memory 83 for storage. The last stored value of Ku will be used in the next performance of Ku adaptation as the initial gain value Ku.

Outputs of a coarse-tune engine 30 or the accumulator 76 are supplied to the multiplier 36 as the gain Ku. As the Ku adaptation is closed-loop, an initial condition of the gain Ku is provided by the coarse-tune engine 82. The coarse-tune (CT) engine 82 can estimate the gain of a modulation varactor (used to add frequencies from the paths 14, 16 in the capacitive domain as discussed above) and convert this gain as the initial condition of the adaptation block 34, and the CT engine 82 is then disabled. Other than for the initial condition of the adaptation block 34, the output of the multiplier 74 is provided via the accumulator 76 to the multiplier 36. The output of the multiplier 74, and thus the memory 83, is provided to the VCO 30 of the PLL 12, via the DAC 38, the analog LPF 40, and the adder 28. The VCO output is fed back to the adaptation block 34 via the prescaler 32, the phase frequency detector (PFD) 22, the charge pump (CP) 24, and the LPF 26. Thus, the adaptation block 34 provides closed-loop VCO gain adaptation.

Example Implementation of the Receiver Baseband Filter

Referring to FIG. 5, an example implementation of the RX BBF 64 shown in FIG. 3 includes two stages 112, 114. The first stage 112 is coupled to the two unity-gain buffers 62 that help provide reverse isolation to lessen the impact of noise or other disturbances in the RX BBF 64 on the analog loop filter. The RX BBF 64 is configured to amplify and filter input signals.

The two stages 112, 114 each include two pairs of resistors, one pair of capacitors, and a differential op-amp. The resistors dictate the DC gain, e.g., with the DC gain of the first stage being −(R₂/R₁). The resistors R₂ are variable resistors whose resistance can be set to program the gain to a desired value. As discussed above, the overall gain of the RX BBF 64 is set so that the output range of the RX BBF 64 will be above the minimum detectable level and lower than a saturation level of the ADC 66. The gain is user-defined and is a one-time setting based on the specifications of the ADC 66. The capacitance values of the capacitors of the stages 112, 114 help define the dominant pole of the RX BBF 64. The capacitors C₁, C₂ combine with the resistors R₂, R₄, respectively, to form single-pole low-pass filters to suppress high-frequency noise. This may help improve the SNR at the input of the ADC 66.

Referring also to FIG. 3, the controller 100 can set the switches 88 to bypass the second stage 114 of the RX BBF 64. The controller 100 sets the switches 88 to be open, as shown in FIG. 3, to use both of the stages 112, 114 of the RX BBF 64. The controller 100 can close the switches 88 that are connected on one end to respective outputs of the RX BBF 1 op-amp shown in FIG. 5, and on other respective ends to respective outputs of the RX BBF 2 op-amp shown in FIG. 5. Closing the switches 88 will cause the second stage 114 of the RX BBF 64 to be bypassed.

Different gain modes of the RX BBF 64 can be programmed to increase the SNR of the signals sent to the ADC 66, fulfilling an ADC INL/DNL requirement. In a low-gain mode, the second stage amplifier is bypassed. In a high-gain mode, both stages of the amplifier are enabled. Fine-tuning gain is available in the two-stage amplifier.

Reuse of the Receiver Baseband Filter and the Adaptation Module ADC

Regarding feature 5 above, the RX BBF 64 is a non-dedicated portion of the Ku adaptation module 34 and can be used for the adaptation block 34 when not in use by a receiver. The RX BBF 64 is thus a multi-use module being capable of being used as part of different larger modules, e.g., a receiver and the adaptation module 34, being used for one module at one time and reused by another module at another time. The RX BBF 64 comprises blocks in any one of the primary, diversity, or feedback receiver and the blocks from an idle one of the receivers can be reused as a pre-amplifier in the adaptation block. The RX BBF 64 in the primary or diversity receiver can be used during non-receiving times for time division duplex (TDD) devices, or the RX BBF in the feedback receiver, or any other idle receiver, can be reused for frequency division duplex (FDD) devices when not in use by another module.

Regarding feature 6 above, the ADC 66 is a non-dedicated portion of the Ku adaptation module 34 and provides several features and appropriate resolution for the Ku adaptation. The ADC 66 can convert the analog outputs of a thermistor, power detector, and other blocks in a transceiver to digital outputs so that the modem can process the temperature, output power, and/or other information of the transmitter for calibration and other test purposes. The number of bits in the multi-bit ADC 66 is programmable (e.g., 8, 10, or 12 bits) and configurable to provide configurable reference voltages from 1.2-2.2V. The ADC 66 has configurable analog-to-digital conversion rates. The higher the resolution used, the lower the conversion rate (i.e., time to convert from analog to digital).

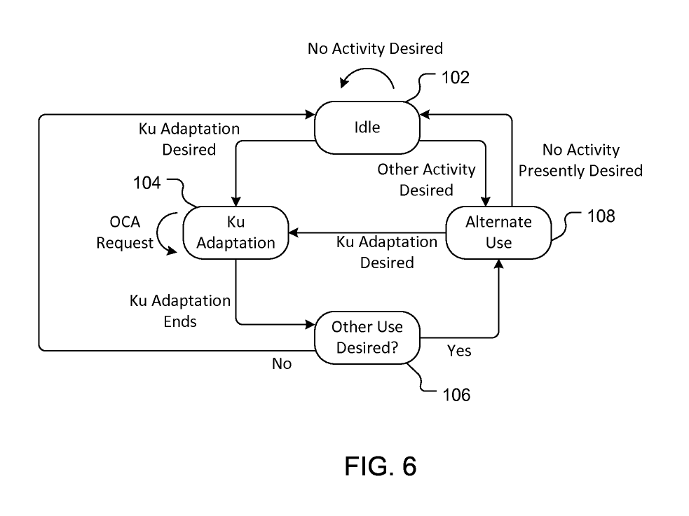

The ADC 66 is preferably only used for the TX synthesizer during Ku adaptation and can be freed for reading the thermistor in TDD mode or reading the thermistor and power detector in FDD mode after the Ku adaptation. An arbiter can be used to manage the requests from the TX synthesizer and other modules of the transceiver according to the ADC status. An example flow-chart of the ADC arbiter is shown in FIG. 6.

Referring to FIGS. 3 and 6, the controller 100 is configured to act as an arbiter of use of the RX BBF 64 and the ADC 66. The controller 100 is configured to regulate the use of the RX BBF 64 and the ADC 66 according to states 102, 104, 106, 108 shown in FIG. 5. The controller 100 controls the switches 84, 86, 90, 91, 92, 94, 96 to implement Ku adaptation and other activities such that the RX BBF 64 and/or the ADC 66 can be used independently by multiple devices of the system 200.

In the state 102, the adaptation module 34 is idle and thus not in use for determining the VCO gain Ku. In this state, the controller 100 monitors one or more criteria to determine if Ku adaptation is to be performed. While in the idle state, if the absence of a desire to perform Ku adaptation or another activity, the controller 100 remains in the idle state 102. In response to detecting a condition to an activity other than Ku adaptation, e.g., in response to a request or one or more other criteria indicative of performance of the other activity being desirable, the controller 100 changes to the state 108. In response to detecting a condition to initiate Ku adaptation, e.g., in response to a request from the Ku adaptation module 34 or one or more other criteria such as before the beginning of a GSM time slot, the controller 100 initiates Ku adaptation and the controller state changes to the state 104.

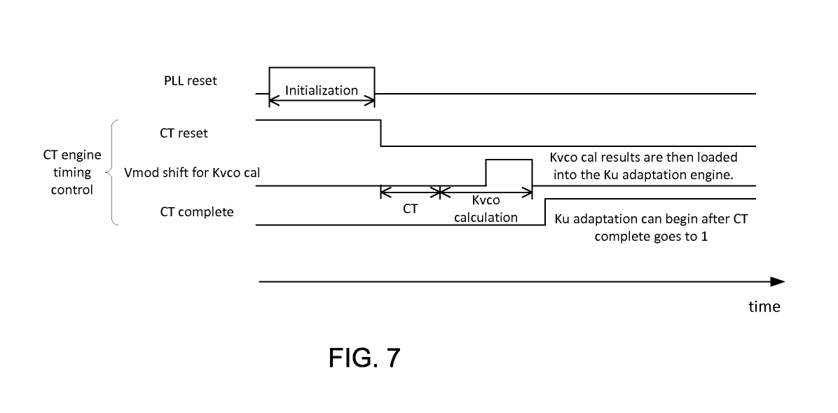

In the state 104, the controller 100 controls switch states to enable the Ku adaptation module 34. The controller 100 sets (actuates or leaves alone, as appropriate) switches 84, 90, 91 to be closed, as shown in FIG. 3, sets switches 86 to be open, as shown in FIG. 3, and sets the selector switch 94 to connect, initially, the CT engine 82 to the memory 83, and later to connect the accumulator 76 to the memory 83, as discussed below with respect to FIG. 7. The controller 100 also sets the switches 88 to be open if both stages of the RX BBF 64 shown in FIG. 5 are to be used. The switches 90, 91 being closed insert the ADC 66 into the Ku adaptation module 34, borrowing the ADC 66 from other activities. The switches 84 being closed and the switches 86 being open insert the RX BBF 64 into the Ku adaptation module 34, borrowing the RX BBF 64 from another device such as the primary, diversity, or feedback receiver. While in the state 104, the Ku adaptation has the first priority. Therefore, the controller 100 will ignore any other on-chip activity (OCA) requests or determinations, and thus the controller 100 stays in the state 104 even if such requests are received or the controller 100 otherwise determines that other conversions are desired. If, however, a request is received or it is otherwise determined that another use of the RX BBF 64 and/or the ADC 66 is desired, the controller 64 will queue such desired use for performance and implement the request once the Ku adaptation is complete. The controller 100 is configured such that in response to the Ku adaptation ending, the controller 100 will change states, moving from the state 104 to the state 106.

In state 106, the controller determines whether another use of the RX BBF 64 and/or the ADC 66 is desired, and moves to either the state 108 or returns to the state 102 as appropriate. In response to the controller 100 determining that there is no other use of the RX BBF 64 and/or the ADC 66 presently desired, e.g., there is no other use queued, then the controller 100 returns to the idle state 102. In response to the controller 100 determining that there is another use of the RX BBF 64 and/or the ADC 66 presently desired, e.g., there is another use queued, then the controller 100 changes states and moves to the state 108.

In state 108, the controller sets appropriate switches for the desired use of the RX BBF 64 and/or the ADC 66. If the ADC 66 is to be used for another conversion, then the controller 100 opens the switches 90, 91. The switches 90, 91 being opened removes the ADC 66 from the Ku adaptation module 34, returning the ADC 66 to the other activities, such as reading the temperature, outputting power, and/or processing other information of the transmitter 10 for calibration and other test purposes from which the ADC 66 was borrowed. If the RX BBF 64 is to be used for another operation, then the controller 100 opens the switches 84 and closes the switches 86. The switches 84 being open and the switches 86 being closed removes the RX BBF 64 from the Ku adaptation module 34, returning the RX BBF 64 to the device, such as the primary, diversity, or feedback receiver, from which the RX BBF 64 was borrowed. The controller 100 further determines whether Ku adaptation or another activity is desired. If another, non-Ku adaptation activity is desired after performance of the present activity ends, then the controller 100 remains in the state 108 for performance of that activity. In response to Ku adaptation being desired at any time while in the state 108, the controller 100 returns to the state 104, overriding and terminating any presently performing activities as appropriate. In response to the present activity completing and neither Ku adaptation nor any other activity being desired, the controller 100 returns to the idle state 102.

Ku Factory Calibration

Regarding feature 4 above, with reference to FIGS. 2-3 and 7, the Ku adaptation module 34 begins with coarse tuning provided by the CT engine 82. The CT engine 82 is shown in FIG. 3 in the Ku adaptation module 34, but may be physically located, at least partially, in the VCO 30.

In response to a request from the modem for use of the transmitter 10, the controller 100 provides a pulse on a PLL reset signal and sets the selector switch 94 to connect the CT engine 82 to the memory 83. At the trailing edge of this pulse, the CT engine 82 starts, shown in FIG. 7 as a CT reset signal transitioning states, as shown from a high state to a low state. The CT engine 82 is configured to induce the VCO 30 to output a signal with approximately the frequency to which the PLL 12 will lock.

As the Ku adaptation module 34 implements a least mean squared algorithm, the module 34 uses an initial value for Ku. This initial value is supplied by the CT engine 82 based upon a gain K_{mod} of the modulation varactor in the VCO 30. The CT engine 82 determines an estimated gain K_{mod} according to

K_{mod}=(f₂−f₁)/(V₂−V₁) (4)

where f₁, f₂ are the frequencies of signals produced by the VCO 30 in response to applied voltages V₁, V₂, respectively. During a CT period shown in FIG. 7, the CT engine 82 provides the two test voltages V₁, V₂ to the VCO 30 and measures the corresponding frequencies f₁, f₂. The CT engine 82 calculates the gain K_{mod} during a K_{mod} calculation time shown in FIG. 7. Then, the CT engine 82 calculates an estimated initial gain value Ku according to

$${K}_{u} = \frac{{f}_{ref}}{{K}_{dac} \cdot {K}_{mod} \cdot {2}^{24}} \qquad ( 5 )$$

where f_{ref} is the reference frequency (fᵣ) input to the PFD (see FIG. 2), and K_{mod} is the estimated gain of the modulation varactor in the VCO 30.

With the initial Ku value determined, Ku adaptation may begin. The CT engine 82 changes a CT complete signal to indicate that the initial Ku value has been determined, here transitioning the CT complete signal from low to high. The Ku adaptation module 34, in particular the controller 100, can respond to this indication by beginning the Ku adaptation.

Ku factory calibration may be eliminated. During factory calibration, Ku adaptation is set to run for a few milliseconds at the lowest and highest channels of each band. The converged Ku is stored and interpolated for each channel. The above mechanism can be replaced by Kmod calculation results from the coarse-tune (CT) engine 82. Kmod calculation results from the CT engine 82 can be used to estimate the initial Ku before each locking.

Operation

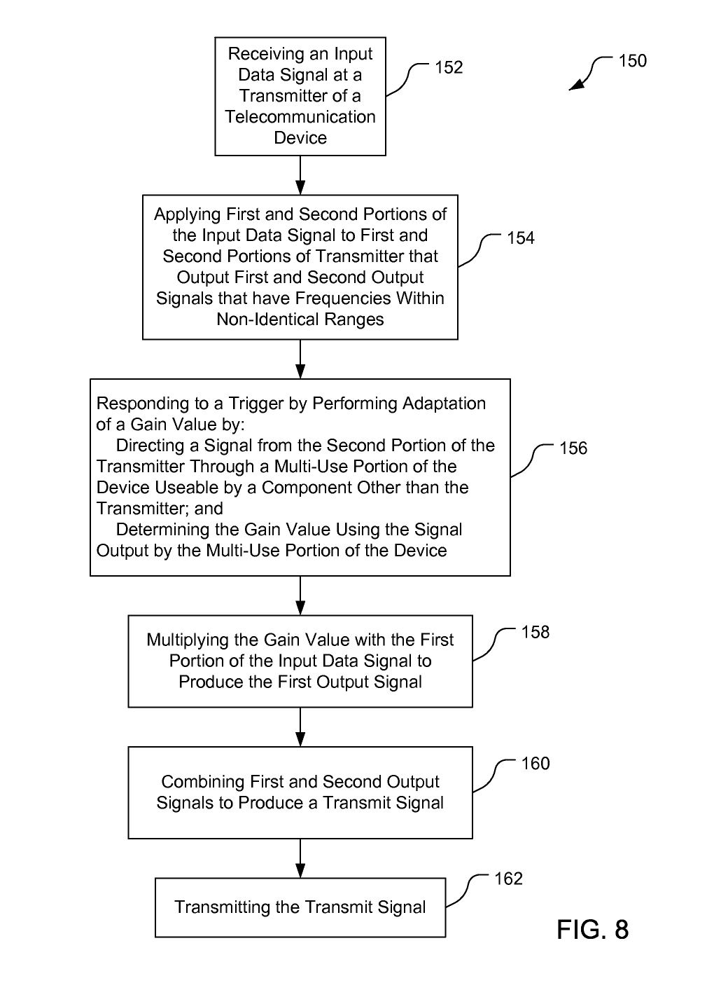

Referring to FIG. 8, with further reference to FIGS. 1-3, a process 150 for transmitting data from a telecommunication device includes the stages shown. The process 150 is an example only and not limiting. The process 150 may be altered, e.g., by having stages added, removed, rearranged, combined, and/or performed concurrently. For example, stages 152 and 154 discussed below may occur after stage 156 discussed below.

At stage 152, the process 150 includes receiving an input data signal at a transmitter of a wireless telecommunication device. Here, the input data signal is received by the transmitter 10 of the device 200. The input data signal may be received from a source external to the transmitter 10 or from a source internal to the transmitter 10, e.g, from a modem at one time and from the dynamic training module 70 at another time.

At stage 154, the process 150 includes applying first and second portions of the input data signal to first and second portions of the transmitter 10. The first and second portions output first and second output signals and these signals have frequencies within non-identical ranges. For example, the input data signal is applied to the high-pass path 14 and the low-pass path 16, with the high-pass path 14 outputting a signal in a frequency range that is higher than a frequency range within which the low-pass path 16 outputs a signal. The frequency ranges may overlap, but are not co-extensive, i.e., have different lower and upper ends.

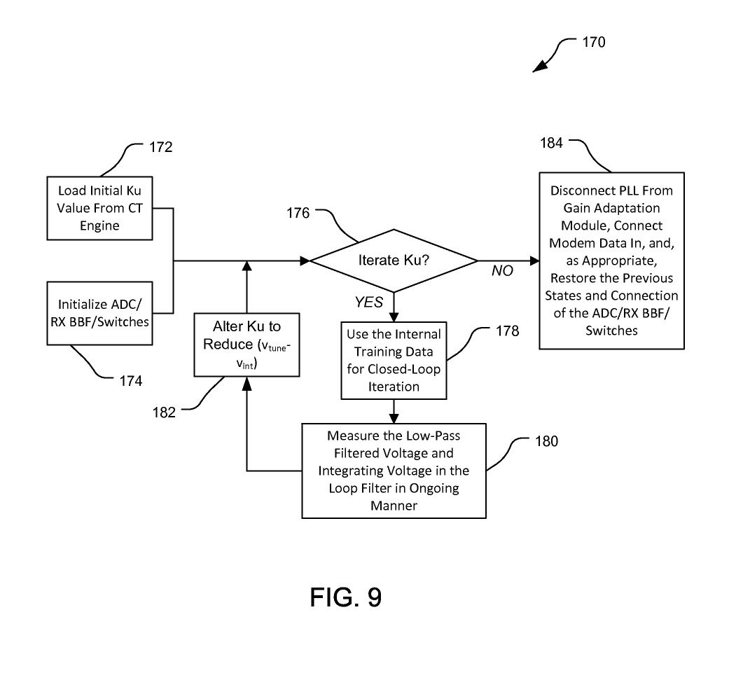

At stage 156, the process 150 includes responding to a trigger by performing adaptation of a gain value for the first output signal. The transmitter 10, e.g., the controller 100, responds to a trigger such as before the beginning of a GSM time slot, by initiating Ku gain calibration. The gain adaptation is discussed more fully below with respect to FIG. 9, but includes directing a first signal from the second portion of the transmitter through a multi-use portion of the device useable by a second component of the device, with the second component of the device being a component of the device other than the transmitter. Here, first and second signals, the Vᵢₙₜ and Vₜᵤₙₑ signals, are directed from the PLL 12 to the Ku adaptation module 34, with the RX BBF 64 and the ADC 66 being multi-use devices useable by at least one of the receivers 212. The gain adaptation further includes determining the gain value using the first signal output by the multi-use portion of the device. The gain value is determined using the difference signal output by the ADC 66 as the error signal as discussed above, with the error signal being derived from the first and second signals, Vᵢₙₜ and Vₜᵤₙₑ. As discussed with respect to FIG. 9 below, in the example of the transmitter 10, the input data signal during stage 156 is the training signal from the dynamic training module 70 while the input data signal during other stages of the process 150 is from a modem by way of the resampler 20.

At stage 158, the process 150 includes multiplying the gain value with the first portion of the input data signal to produce the first output signal. The gain value may be multiplied by the first portion of the input data signal before any processing of the first portion of the input data signal, or after some amount of processing. Thus, the first portion of the input data signal may refer to various stages of this signal, e.g., after conversion by the DAC 38, after filtering by the LPF 40, etc.

At stage 160, the process 150 includes combining the first and second output signals to produce a transmit signal. Here, the signals from the high-pass path 14 and the low-pass path 16 through the PLL 12 are combined by the adder 28.

At stage 162, the process 150 includes transmitting the transmit signal to transmit data corresponding to the input data signal. The transmitter 10 transmits the transmit signal via at least one of the antennas 210 to transmit the data contained in the input data signal.

Referring to FIG. 9, with further reference to FIGS. 1-4 and 6-7, a process 170 of performing gain adaptation includes the stages shown. The process 170 may be used for the stage 156 shown in FIG. 8. The process 170 is an example only and not limiting. The process 170 may be altered, e.g., by having stages added, removed, rearranged, combined, performed concurrently, and/or performed serially instead of concurrently.

At stage 172, an initial Ku value is loaded into the memory 83 from the CT engine 82. The controller 100 sets the switch 94 to connect the CT engine 82 to the memory 83. This stage includes initializing the PLL 12, resetting the CT engine 82, providing test voltages, determining the K_{mod} value according to Eqn. (4), and determining the initial Ku value according to Eqn. (5). Once the initial Ku value is loaded into the memory 83 from the CT engine 82, the controller 100 sets the switch 94 to connect the accumulator 76 to the memory 83.

At stage 174, and preferably concurrently with stage 172, the ADC 66, RX BBF 64, and the switches 84, 86, 88, 90, 91, 92, 96 are initialized. The controller 100 closes, if not closed already, the switches 84, 90, 91, opens, if not open already, the switches 86, 88, 92, and sets the switch 96 to connect the dynamic training module 70 to the multipliers 36, 42. The ADC 66 and the RX BBF 64 are initialized by having bias voltages and bias currents set up. For example, digital control signals are sent to initialize the number of bits of the ADC 66 and the gain/bandwidth of the RX BBF 64.

At stage 176, an inquiry is made as to whether the gain value Ku should be iterated. The controller 100 determines whether a desired condition has been met, e.g., that the process 170 has been performed longer than a threshold time predetermined to adapt the gain Ku to a satisfactory or sufficient value, e.g., such that the error signal ε has a desired value, e.g., less than about 3% of Vₜᵤₙₑ or Vᵢₙₜ or less than about 1% of Vₜᵤₙₑ or Vᵢₙₜ. Alternatively, the controller 100 determines whether the error signal has a desired value. For example, the desired value may result in the transmitter 10 meeting one or more performance criteria such as phase error and error vector magnitude (EVM) in accordance with GSM requirements. If the controller 100 determines not to iterate Kᵤ, then the process 170 proceeds to stage 184, and if the controller 100 determines to iterate Kᵤ, then the process 170 proceeds to stage 178.

At stage 178, the internal training data are used for closed-loop iteration. The controller 100 causes the dynamic training module 70 to provide the training signal to the multipliers 36, 42, 74. The controller 100 transitions from either the idle state 102 or the alternate use state 108 to begin the Ku adaptation.

At stage 180, the low-pass filtered voltage Vₜᵤₙₑ and the integrating voltage Vᵢₙₜ are measured in an ongoing manner. These voltages are passed through the borrowed portions of the receiver, i.e., the RX BBF 64 and the ADC 66, to determine the error signal ε.

At stage 182, the gain value Ku is altered/iterated to reduce the error signal ε. The DC offset of the error signal ε is dynamically compensated, the training signal is dynamically adjusted, the bandwidth constant γ is dynamically adjusted, and the error signal, the training signal, and the bandwidth constant are multiplied and accumulated to determine the gain value Ku according to Eqn. (3). The process 170 then returns to stage 176.

At stage 184, the controller 100 disconnects the PLL 12 from the gain adaptation module 34, connects the modem data to the transmitter 10, and, as appropriate, changes states or restores previous states and connections of the RX BBF 64, the ADC 66, and the switches 86, 88, 90, 91, 92, 96. With Ku adaptation complete, the controller 100 sets the switch 96 to connect the resampler 20 to the multipliers 36, 42. The controller 100 also opens the switches 84 to disconnect the PLL 12, specifically the LPF 26, from the module 34. If no alternate use of the RX BBF 64 and the ADC 66 is desired (see state 106 in FIG. 6), then the connections of the switches 88, 90, 91, 92 may remain as is, and otherwise be changed such that switches 86, 88, 92 are closed and switches 90, 91 are open. The memory 83 is still connected to the multiplier 36 and thus continues to supply the gain value Ku to the multiplier 36 to balance the signals input to the adder 28.

Other Considerations

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

Further, as used herein, “coupled” may mean indirectly coupled or directly coupled. For example, in FIG. 2 the VCO 30 is coupled to the multiplier 36, in this example, indirectly coupled.

Also, a signal may be referred to by the same name at different stages of processing. Thus, for example, a signal may be referred to by the same name at different points in the transmitter 10, e.g., different points in the high-pass path 14, different points in the low-pass path 16, or different points in the gain adaptation module 34.

What is claimed is:

1. A wireless device comprising:
an antenna; and
a polar-modulation transmitter coupled to the antenna and configured for two-point modulation, the transmitter comprising:
a data input;
a first signal path including a multiplier coupled to the data input and a voltage-controlled oscillator gain adaptation module coupled to the multiplier and configured to provide a gain value to the multiplier; and
a second signal path coupled to the data input and including an analog phase-locked loop (PLL) including a voltage-controlled oscillator (VCO) coupled to the first signal path.

2. The device of claim 1 further comprising at least one receiver including a pre-amplifier and an analog-to-digital converter (ADC), wherein the gain adaptation module includes the pre-amplifier and the ADC.

3. The device of claim 2 wherein the at least one receiver includes a primary receiver, a diversity receiver, and a feedback receiver, and wherein the gain adaptation module is configured to use the pre-amplifier and the ADC of a selected receiver of the at least one receiver during an idle time of the selected receiver.

4. The device of claim 1 wherein the PLL includes a low-pass filter (LPF) and the pre-amplifier has a first input coupled to a zero of the LPF and a second input coupled to any one pole from a first to a last pole of the LPF.

5. The device of claim 4 wherein the pre-amplifier is configured to determine a difference between a signal received by the first input and a signal received by the second input to remove a DC component of the signal sent to the ADC.

6. The device of claim 4 wherein the LPF comprises a passive resistive-capacitive ladder, or an active filter with equal numbers of poles and zeros, with a second or higher pole being the final pole of the LPF.

7. The device of claim 1 further comprising a coarse-tune engine selectively coupled to the multiplier and configured to provide an initial value for the adjustable gain value in an open-loop manner.

8. The device of claim 1 wherein the gain adaptation module comprises a dynamic adjustment module configured to at least one of:
provide a dynamic step of data provided to the data input;
provide a dynamic bandwidth adjustment to a data signal received at the data input; or
dynamically adjust a direct-current (DC) offset of an output of a signal multiplied by the data signal received at the data input.

9. A method of transmitting data from a wireless telecommunication device, the method comprising:
receiving an input data signal at a transmitter of the device, the transmitter being a first component of the device;
applying first and second portions of the input data signal to first and second portions of the transmitter that output first and second output signals that have frequencies within first and second frequency ranges that are non-identical;
responding to a trigger by performing adaptation of a gain value for the first output signal, the adaptation comprising:
directing a first signal from the second portion of the transmitter through a multi-use portion of the device useable by a second component of the device, the second component of the device being a component of the device other than the transmitter;
determining the gain value using the first signal output by the multi-use portion of the device; and
multiplying the gain value with the first portion of the input data signal to produce the first output signal;
combining the first and second output signals to produce a transmit signal; and
transmitting the transmit signal to transmit the data.

10. The method of claim 9 wherein the directing comprises directing the first signal through a filter and an analog-to-digital converter of a receiver of the device.

11. The method of claim 9 wherein the directing further comprises directing a second signal from the second portion of the transmitter through the portion of the second component, wherein using the first signal comprises taking a difference of the first and second signals from the second portion of the transmitter and wherein determining the gain value comprises iterating the gain value to reduce the difference.

12. The method of claim 11 further comprising applying a direct current offset to the difference.

13. The method of claim 12 wherein applying the direct current offset comprises applying different direct current offsets at different times.

14. The method of claim 11 further comprising:
providing a training signal as in the input data signal; and
multiplying the difference by the training signal and a constant.

15. The method of claim 14 further comprising varying both a period of the training signal and a value of the constant over time.

16. The method of claim 9 wherein the directing comprises connecting the multi-use portion of the device to the first portion of the transmitter.

17. The method of claim 9 further comprising frequency filtering the first and second portions of the input data signal by the first and second portions of the transmitter such that the first frequency range includes frequencies higher than the second frequency range.

18. The method of claim 9 wherein directing the first signal from the second portion of the transmitter through the multi-use portion of the device comprises directing the first signal through the multi-use portion of the device during an idle time of the second component of the device.

19. The method of claim 9 further comprising:
iterating the gain value to an adapted gain value such that the first and second output signals have a desired characteristic; and
storing the adapted gain value;
wherein multiplying the gain value with the first portion of the input data signal comprises multiplying the adapted gain value once the adapted gain value is determined.

20. A wireless device comprising:
means for receiving an input data signal at a transmitter of the device, the transmitter being a first component of the device;
means for applying first and second portions of the input data signal to first and second portions of the transmitter that output first and second output signals that have frequencies within first and second frequency ranges that are non-identical;
means for responding to a trigger by means for performing adaptation of a gain value for the first output signal in response to a trigger, the means for performing comprising:
means for directing a first signal from the second portion of the transmitter through a multi-use portion of the device useable by a second component of the device, the second component of the device being a component of the device other than the transmitter;
means for determining the gain value using the first signal output by the multi-use portion of the device; and
means for multiplying the gain value with the first portion of the input data signal to produce the first output signal;
means for combining the first and second output signals to produce a transmit signal; and
means for transmitting the transmit signal to transmit the data.

21. The device of claim 20 wherein the means for directing comprises means for directing the first signal through a filter and an analog-to-digital converter of a receiver of the device.

22. The device of claim 20 wherein the means for directing further comprises means for directing a second signal from the second portion of the transmitter through the portion of the second component, wherein using the first signal comprises taking a difference of the first and second signals from the second portion of the transmitter and wherein the means for determining the gain value comprises means for iterating the gain value to reduce the difference.

23. The device of claim 22 further comprising means for applying a direct current offset to the difference.

24. The device of claim 23 wherein the means for applying the direct current offset comprises means for applying different direct current offsets at different times.

25. The device of claim 22 further comprising:
means for providing a training signal as in the input data signal; and
means for multiplying the difference by the training signal and a constant.

26. The device of claim 25 further comprising means for varying both a period of the training signal and a value of the constant over time.

27. The device of claim 20 wherein the means for directing comprises means for connecting the multi-use portion of the device to the first portion of the transmitter.

28. The device of claim 20 further comprising means for frequency filtering the first and second portions of the input data signal by the first and second portions of the transmitter such that the first frequency range includes frequencies higher than the second frequency range.

29. The device of claim 20 wherein the means for directing the first signal from the second portion of the transmitter through the multi-use portion of the device comprises means for directing the first signal through the multi-use portion of the device during an idle time of the second component of the device.

30. The device of claim 20 further comprising:
means for iterating the gain value to an adapted gain value such that the first and second output signals have a desired characteristic; and
means storing the adapted gain value;
wherein multiplying the gain value with the first portion of the input data signal comprises multiplying the adapted gain value once the adapted gain value is determined.

31. A processor-readable storage medium comprising processor-readable instructions configured to cause a processor to:
cause first and second portions of an input data signal, received at a transmitter of a wireless device, to be applied to first and second portions of the transmitter that output first and second output signals that have frequencies within first and second frequency ranges that are non-identical, the transmitter being a first component of the device;
respond to a trigger by performing adaptation of a gain value for the first output signal, the adaptation comprising:
directing a first signal from the second portion of the transmitter through a multi-use portion of the device useable by a second component of the device, the second component of the device being a component of the device other than the transmitter;
determining the gain value using the first signal output by the multi-use portion of the device; and
multiplying the gain value with the first portion of the input data signal to produce the first output signal;
combine the first and second output signals to produce a transmit signal; and
transmit the transmit signal to transmit the data.

32. The processor-readable storage medium of claim 31 wherein the directing comprises directing the first signal through a filter and an analog-to-digital converter of a receiver of the device.

33. The processor-readable storage medium of claim 31 wherein the directing further comprises directing a second signal from the second portion of the transmitter through the portion of the second component, wherein using the first signal comprises taking a difference of the first and second signals from the second portion of the transmitter and wherein determining the gain value comprises iterating the gain value to reduce the difference.

34. The processor-readable storage medium of claim 33 further comprising instructions configured to cause the processor to apply a direct current offset to the difference.

35. The processor-readable storage medium of claim 34 wherein the instructions configured to cause the processor to apply a direct current offset are configured to cause the processor to apply different direct current offsets at different times.

36. The processor-readable storage medium of claim 33 further comprising instructions configured to cause the processor to:
provide a training signal as in the input data signal; and
multiply the difference by the training signal and a constant.

37. The processor-readable storage medium of claim 36 further comprising instructions configured to cause the processor to vary both a period of the training signal and a value of the constant over time.

38. The processor-readable storage medium of claim 31 wherein the directing comprises connecting the multi-use portion of the device to the first portion of the transmitter.

39. The processor-readable storage medium of claim 31 further comprising instructions configured to cause the processor to frequency filter the first and second portions of the input data signal by the first and second portions of the transmitter such that the first frequency range includes frequencies higher than the second frequency range.

40. The processor-readable storage medium of claim 31 wherein directing the first signal from the second portion of the transmitter through the multi-use portion of the device comprises directing the first signal through the multi-use portion of the device during an idle time of the second component of the device.

41. The processor-readable storage medium of claim 31 further comprising instructions configured to cause the processor to:
iterate the gain value to an adapted gain value such that the first and second output signals have a desired characteristic; and
store the adapted gain value;
wherein the instructions configured to cause the processor to multiply the gain value with the first portion of the input data signal comprise instructions configured to cause the processor to multiply the adapted gain value once the adapted gain value is determined.
